(19) United States
(12) Patent Application Publication
(10) Pub. No.: US 2014/0176607 A1
(43) Pub. Date: Jun. 26, 2014

(54) SIMULATION SYSTEM FOR MIXED REALITY CONTENT

(71) Applicant: Electronics & Telecommunications Research Institute, Daejeon (KR)

(72) Inventors: Ung Yeon YANG, Daejeon (KR); Ki Hong Kim, Daejeon (KR)

(73) Assignee: Electronics & Telecommunications Research Institute, Daejeon (KR)

(21) Appl. No.: 14/140,074

(22) Filed: Dec. 24, 2013

(30) Foreign Application Priority Data
Dec. 24, 2012 (KR) 10-2012-0151987

(51) Int. Cl. G06T 19/00; G06F 17/50

(52) U.S. Cl. CPC G06T 19/006; G06F 17/5009
USPC 345/633

(57) ABSTRACT

Disclosed is a simulation system for mixed reality content. A simulation system according to the present invention may comprise at least one real object for demonstrating contents configured with a tracking sensor, a multi-modal input-output apparatus tracking the at least one real object and collecting information on the at least one real object and a content authoring apparatus configured to edit virtual contents according to a predefined scenario, receive the information on the at least one real object collected by the multi-modal input-output apparatus, and edit the virtual contents based on the information on the at least one real object and a user feedback.

### CLAIM FOR PRIORITY

This application claims priorities to Korean Patent Application No. 10-2012-0151987 filed on Dec. 24, 2012 in the Korean Intellectual Property Office (KIPO), the entire contents of which are hereby incorporated by references.

### BACKGROUND

1. Technical Field

Example embodiments of the present invention relate to a simulation system for mixed reality content, and more specifically to a system for simulating and authoring mixed reality content interacting with real world objects.

2. Related Art

Although conventional virtual reality is only for virtual space and object, mixed reality may synthesize virtual object on real world and provide additional augmented information which is difficult to be obtained from only real world. That is, mixed reality augments effect of real world by synthesizing virtual objects onto real world objects as opposed to virtual reality completely based on virtual world.

According to such the characteristics, mixed reality can be applied to various real environments as opposed that virtual reality can be applied only to limited domain such as game. Especially, mixed reality is being remarked as a next generation display technology suitable for ubiquitous environment.

A conventional technology related to mixed reality controls virtual camera for three dimension contents which will be visualized in respective display apparatus, and make rendering the result in virtual space by using three dimensional graphic technologies. However, the conventional technology omits an intermediate procedure of realizing simulation result of virtual space into real space and realizes only the final result so that reality degrades.

Also, conventional N-screen technologies are technologies implemented in consideration of a situation that contents experienced by users are continuously and persistently represented via respective information display devices. However, since respective display device outputs the same information, integrated situation considering positions and characteristics of devices cannot be produced.

For example, a virtual camera system used in producing movie ‘Avatar’ which was directed by James Cameron is a system utilizing mixed reality technologies and visualizing scenes in which on-site studio and virtual (intermediate or completed) images are synthesized. However, since the system is used only for checking results produced by various devices in the field, the system has lack of functions of changing photographing conditions and authoring content interactively.

### SUMMARY

Accordingly, example embodiments of the present invention are provided to substantially obviate one or more problems due to limitations and disadvantages of the related art.

Example embodiments of the present invention provide a mixed reality simulation system which can author mixed reality content interactively to real world.

In some example embodiments, a simulation system for mixed reality contents may comprise at least one real object for demonstrating contents configured with a tracking sensor, a multi-modal input-output apparatus tracking the at least one real object and collecting information on the at least one real object, and a content authoring apparatus configured to edit virtual contents according to a predefined scenario, receive the information on the at least one real object collected by the multi-modal input-output apparatus, and edit the virtual contents based on the information on the at least one real object and a user feedback.

Here, the content authoring apparatus may comprise an information collecting part receiving the information on the at least one real object collected by the multi-modal input-output apparatus, a simulation processing part editing the virtual contents according to the predefined scenario or editing the virtual contents based on the information on the at least one real object received from the information collecting part, a user interface part receiving the user feedback on the virtual contents edited in the simulation processing part and an information output part outputting the virtual contents edited in the simulation processing part, wherein the simulation processing part is configured to edit the virtual contents additionally based on the user feedback inputted through the user interface part.

Here, the user interface part may be configured to author positions and operation states of the virtual contents represented by the real object for demonstrating contents according to various positions and angles.

Here, when the at least one real object is a display device, the user interface part may be configured to set regions in charge of the virtual contents for each display device.

Here, information on the regions in charge of the virtual contents for each display device may be transferred as configuration parameters of a virtual camera controlling visualization of each display device through the information output part.

Here, the multi-model input-output apparatus may manage the information on the at least one real object by using radio frequency identification (RFID).

Here, the tracking sensor may have six degrees of freedom (DOF).

Here, the information on the at least one real object may include at least one of an identification information of the at least one real object, information of six degrees of freedom (DOF), a visual information, a hearing information, a tactile information, and an olfactory information.

In another example embodiments, a content authoring apparatus may comprise an information collecting part receiving information on at least one real object for demonstrating contents from a multi-modal input-output apparatus collecting information on the at least one real object for demonstrating contents, a simulation processing part editing the virtual contents according to a predefined scenario or editing the virtual contents based on the information on the at least one real object received from the information collecting part, a user interface part receiving a user feedback on the virtual contents edited in the simulation processing part, and an information output part outputting the virtual contents edited in the simulation processing part, wherein the simulation processing part is configured to edit the virtual contents additionally based on the user feedback inputted through the user interface part.

Here, the user interface part may be configured to author positions and operation states of the virtual contents represented by the real object for demonstrating contents according to various positions and angles.

Here, when the at least one real object is a display device, the user interface part may be configured to set regions in charge of the virtual contents for each display device.

Here, information on the regions in charge of the virtual contents for each display device may be transferred as configuration parameters of a virtual camera controlling visualization of each display device through the information output part.

Here, the information on the at least one real object may include at least one of an identification information of the at least one real object, information of six degrees of freedom, a visual information, a hearing information, a tactile information, and an olfactory information.

### BRIEF DESCRIPTION OF DRAWINGS

Example embodiments of the present invention will become more apparent by describing in detail example embodiments of the present invention with reference to the accompanying drawings, in which:

FIG. 1 is a block diagram to show a configuration of a simulation system for mixed reality content according to an example embodiment of the present invention;

FIG. 2 is a block diagram to show detail components of a content authoring device according to an example of the present invention;

FIG. 3A and FIG. 3B are conceptual diagrams to show a procedure of authoring and demonstrating a virtual content in a simulation system for mixed reality according to an example of the present invention;

FIGS. 4A to 4E are views to show various examples of implementation for a simulation system for mixed reality content according to an example of the present invention; and

FIG. 5 is a view to explain a procedure that a producer configures an optimal demonstration environment, in a space shown in FIG. 4A, according to a scenario while the producer is moving.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

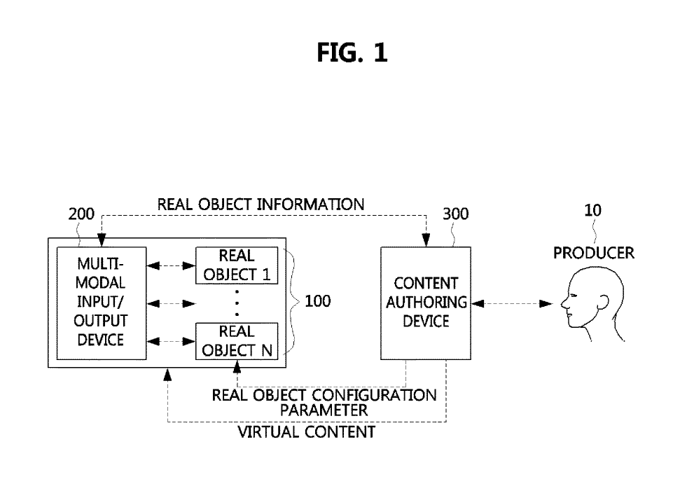

FIG. 1 is a block diagram to show a configuration of a simulation system for mixed reality content according to an example embodiment of the present invention.

Referring to FIG. 1, a simulation system for mixed reality content according to an example embodiment of the present invention may be configured to comprise at least one real object for content demonstration 100, a multi-modal input-output device 200, and a content authoring device 300.

Also, referring to FIG. 1, each component of the simulation system for mixed reality content according to an example embodiment of the present invention may be explained as follows.

According to a content scenario, at least one real object for content demonstration equipped with a sensor tracking 6 degrees of freedom (6 DOF; positional information—X, Y, and Z and pose information—Pitch, Yaw, and Roll) may be disposed in respective different position within a demonstration space.

The multi-modal input-output device 200 may track the at least one real object for content demonstration 100 disposed within the demonstration space, and manage information on the at least one real object for content demonstration, for example, information on identifier (name, shape, function, and so on) and information on 6 DOF within the space by using a specific protocol (for example, recognition of ID by RFID, authoring the information by using database construction tool). Also, the information on the at least one real object for content demonstration 100 may include at least one of a visual information, a olfactory information, a tactile information, a hearing information, and the like.

The content authoring device 300 may be configured to edit virtual content according to a predefined scenario, receive the information on the real object for content demonstration collected in the multi-modal input-output device 200, and edit the virtual content based on the information on the real object 100 and a user feedback.

In the above mentioned manner, mixed reality environment may be implemented by matching the virtual content to the real object based on the information on the real object. The simulation system for mixed reality content according to an example embodiment of the present invention may author various multi-modal feedback effects such as hearing, tactile, and olfactory effect as well as visualization technology (for example, controlling virtual camera effect).

Hereinafter, detail configuration of the content authoring device 300 is explained.

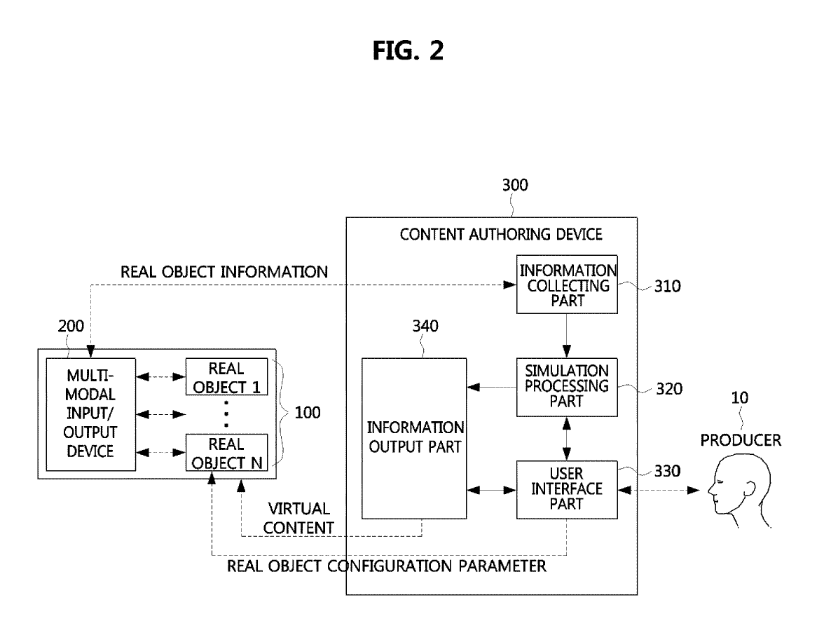

FIG. 2 is a block diagram to show detail components of a content authoring device according to an example of the present invention.

Referring to FIG. 2, a content authoring device according to an example of the present invention may be configured to comprise an information collecting part 310, a simulation processing part 320, a user interface part 330, and an information output part 340.

Also, referring to FIG. 2, role of respective component of the content authoring device according to an example of the present invention and mutual relations between the components may be explained in further detail as follows.

The information collecting part 310 may receive the information on the real object for content demonstration 100 collected in the multi-modal input-output device 200.

The simulation processing part 320 may edit virtual content according to a predefined scenario, or edit the virtual content based on the information on the real object for content demonstration 100 received from the information collecting part 310.

Here, the information on the at least one real object for content demonstration 100 may include at least one of a visual information, a olfactory information, a tactile information, a hearing information, and the like.

The user interface part 330 may process user inputs for authoring content (for example, user inputs through keyboard, mouse, touchpad, voice command, and so on). For example, the user interface part 330 may receive user feedback to virtual content edited in the simulation processing part 320, and edit the virtual content again by applying the user feedback through the simulation processing part 320. Meanwhile, the user interface part 330 may be implemented as a portable device, and a user may move with it in a content demonstration space so as to author locations and operation states of the virtual contents represented by the respective real object for content demonstration by using the user interface part 330.

Also, if the real object for content demonstration 100 is a display device, regions in charge of representing virtual content may be set for the respective display device by the user interface part 330. At this time, information on regions for the respective display device 100 set by the user interface part 330 may be transferred as configuration parameters controlling visualization of the respective display device 100 through the information output part 340.

The information output part 340 may be configured to output the virtual content processed through the simulation processing part 320 or the user interface part 330, or transfer configuration parameters for each real object 100 to each real object 100. At this time, an apparatus for visualizing remote and augmented reality on the mixed reality content may be utilized.

Although only visualization technology (controlling virtual camera effects) is explained in the content authoring device 300 according to an example of the present invention, in another embodiment of the present invention, the information collecting part 310 of the content authoring device 300 may collect information (for example, various sensible element which can be represented to users such as sound, vibration, smell and the like) from the multi-modal input-output device 200, the user interface part 330 may author whether or not to activate various sensible effect (such as sound, vibration, smell and the like) functions of each real object based on the user feedback, and the simulation processing part 320 may process a situation that each sensible effect function operates virtually.

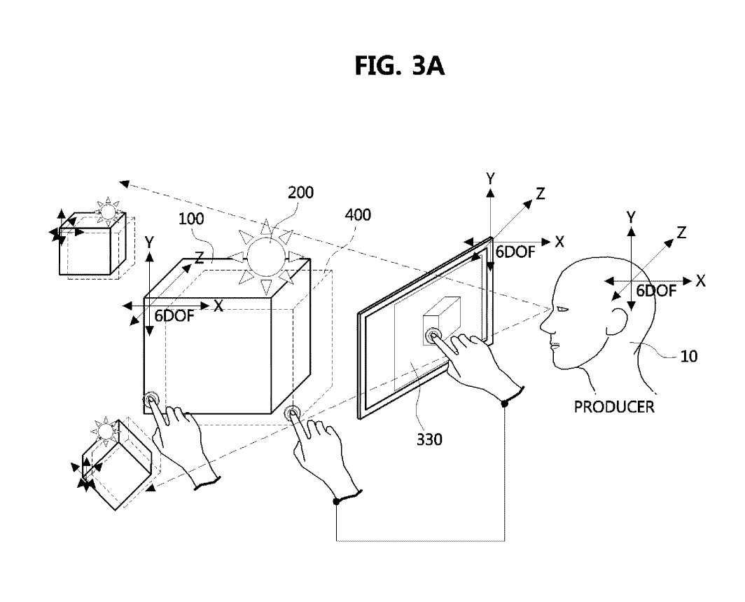

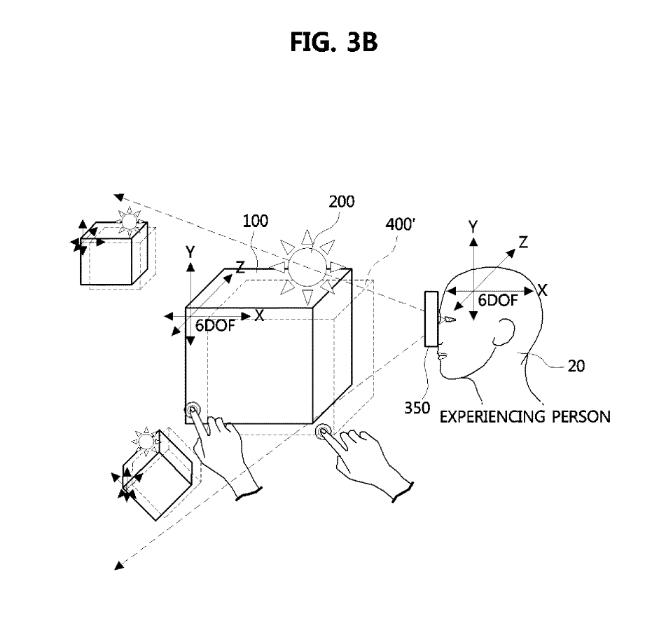

FIG. 3A and FIG. 3B are conceptual diagrams to show a procedure of authoring and demonstrating a virtual content in a simulation system for mixed reality according to an example of the present invention.

Referring to FIG. 3A, virtual content 400 is corresponding to each of a plurality of real object 100, and all of the interactive real objects are configured to be traceable by the multi-modal input-output device 200. The user 10 may move freely in a demonstration space of mixed reality content, observe a content environment from various view points and angle by using a portable user interface part 330, and author appropriate positions and operation states of the virtual content 400.

For example, if the real object 100 is a display device, parameters controlling information visualization techniques such as material of three dimensional content which is represented by each display device (for example, movement path of three dimensional object in a space) and matrix information for three dimensional rendering camera may be modified.

After the procedure of content authoring as explained above, as shown in FIG. 3B, the user 10 may interactively use the virtual content 400′ matched to the real object through a visualization interface 350 in mixed reality space.

Here, for example, the visualization interface 350 may include a Head Mounted Display (HMD), an Eye-Glasses Type Display (EGD), and a portable smart device.

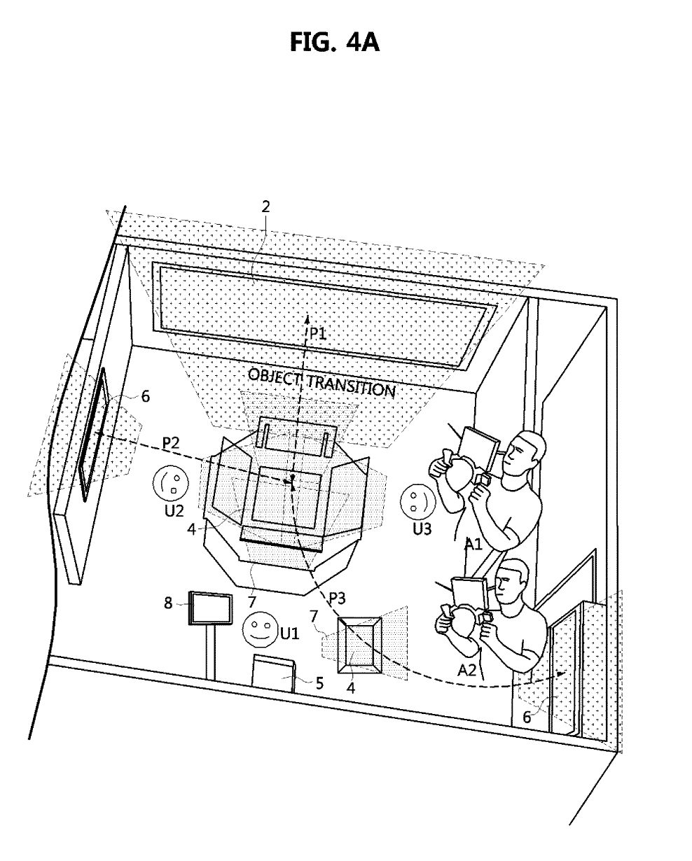

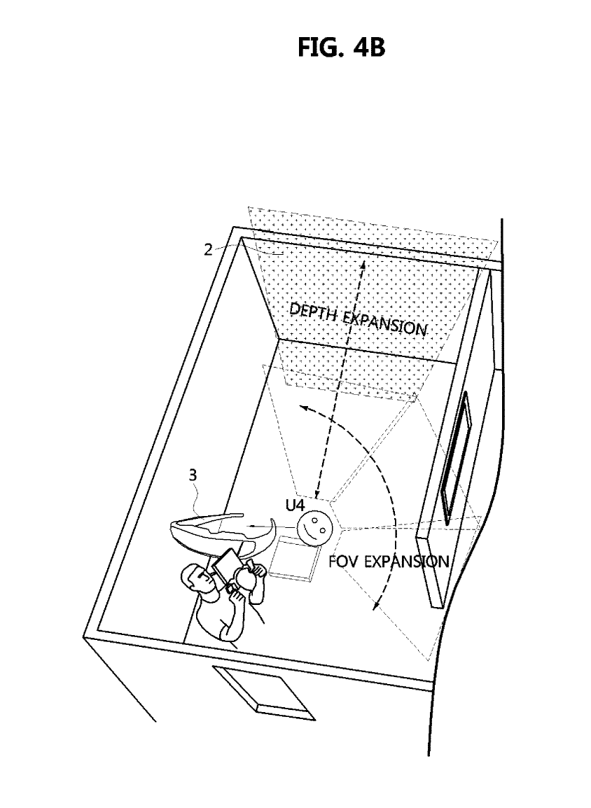

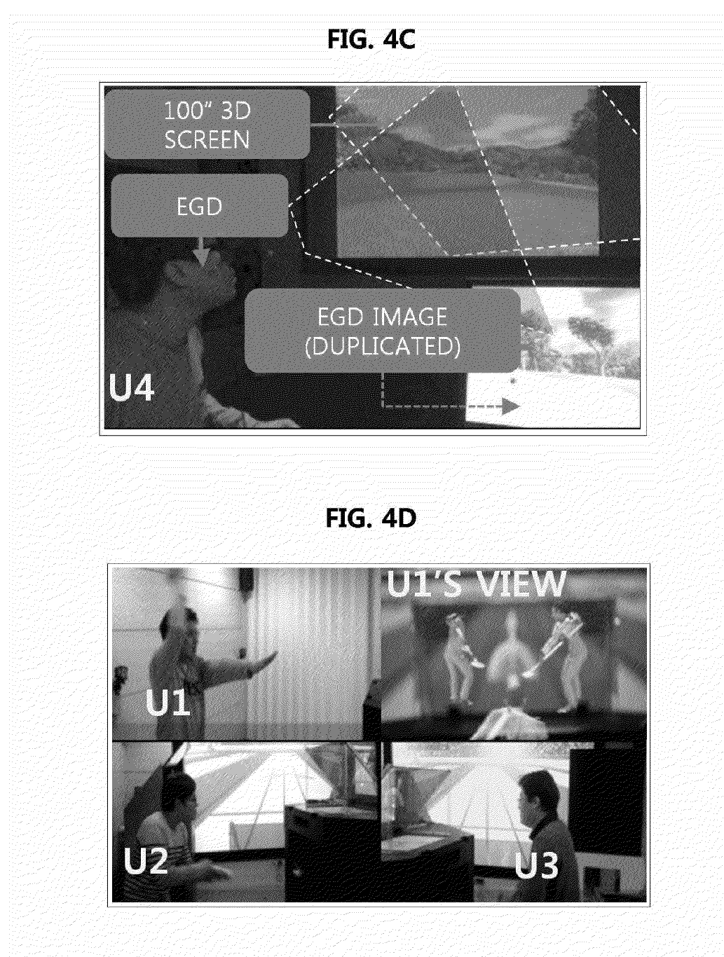

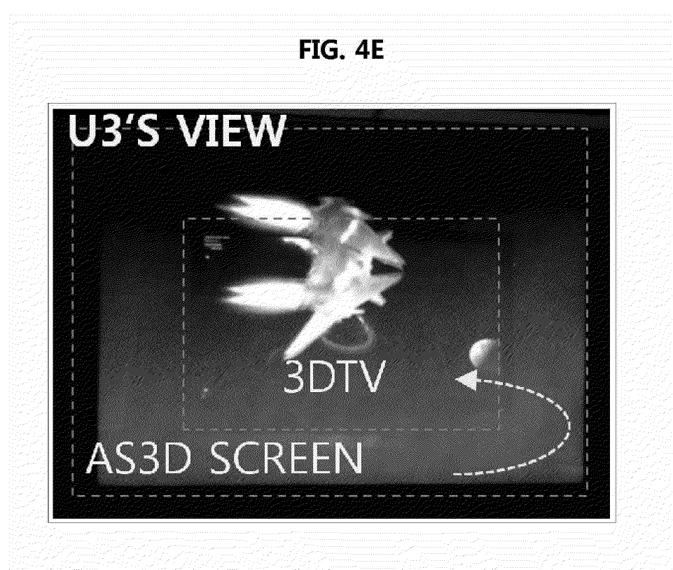

FIGS. 4A to 4E are views to show various examples of implementation for a simulation system for mixed reality content according to an example of the present invention.

Referring to FIG. 4A, a tracking system 1, which can track information on 6 DOF of objects existing in space, is built in all of the walls, and a projection screen 2 used for visualization of virtual content is equipped in a wall. Also, there may be a wearable mixed reality display device 3, a levitation-type three dimensional image visualization device 4, a projector device 5 for projecting three dimensional image to the projection screen 2, and a wall-mounted large sized three dimensional TV. Also, there may be a gesture interface device 7 which can track motion and shape of user's entire body and a touch screen based input-output device 8 which can control operation of the system by using graphical user interface (GUI) as interface devices. Experiencing persons u1, u2, and u3 and producers authoring mixed reality content a1 and a2 are located in the space. It is possible that they author and demonstrate the virtual content while moving around in the space.

First, FIG. 4B represents a space constructed for demonstrating virtual golf, and FIG. 4C represents a perspective of a person experiencing the space for demonstrating virtual golf in FIG. 4B.

Generally, there is a limit to represent feeling of three dimensional space in a virtual screen golf system using projection screen. That is, since a single wall screen has a limit to represent a natural depth in space (for example, representing a feeling of protrusion from screen and or a feeling of receding from screen) and a range from left to right, a golf ball and a hole-cup located just in front of user's foot near putting hole cannot be represented, and natural scenery beyond the screen cannot be represented. Also, even in a recent virtual golf system environment using three wall screens, there is a limit to represent a three dimensional depth in space.

In order to overcome the above mentioned problem, the simulation system shown in FIG. 4B according to an example of the present invention has a configuration that a producer may directly author mixed reality content by controlling three dimensional rendering virtual camera to control three dimensional space displayed by respective display device.

A producer a3 may observe a content demonstration space with a mobile user interface device, and author an optimal three dimensional effect of space for which the projection screen 2 is responsible by referring to positions of an experiencing person u4 and the projection screen 2. For example, the projection screen 2 may be responsible for representing content up to 1 meter in front of the projection screen, and the wearable device 3 may be responsible for representing content in space up to an experiencing person u4 and in surrounding space.

Accordingly, when the experiencing person u4 is looking to the forward direction around a putting hole, the experiencing person u4 can see a golf field in the far distance displayed through the projection screen 2, and a golf ball and a hole cup located underfoot displayed through the wearable device 3.

Referring to FIG. 4A and FIG. 4D, an example of mixed reality content in which a plurality of heterogeneous display devices are interworking with each other in order to represent astrospace is shown. In the mixed reality content, a space ship is controlled by a gesture interface 7 to move through three dimensional space which each of the display devices is in charge of.

Producers a1 and a2 may set three dimensional visualization spaces (represented as trapezoids of dotted line) for which each display device is responsible from various observation points, and locate a levitation type relocatable three dimensional visualization device 4 in a position optimized according to a scenario.

After configuring positions of the display devices and parameter of the virtual camera for the three dimensional space of each display device to be continued naturally, movements of objects (for example, a space ship) to be represented may be authored.

For example, an experiencing person u1 may observe an effect that a space ship flies in a displayed space through p1, p2, and p3 by using arrows p1, p2, and p3.

Referring to FIG. 4A and FIG. 4E, an example of mixed reality content in which curling of winter Olympic sports is experienced is shown. The producers a1 and a2 may visualize content which will be exposed to experiencing persons u1, u2, and u3 by using an authoring device in positions of the experiencing persons u1, u2, and u3 in advance of exposing the content to the experiencing persons. Also, at the same time, the producers a1 and a2 may verify formal data types such as size of content, or modify movements of objects directly.

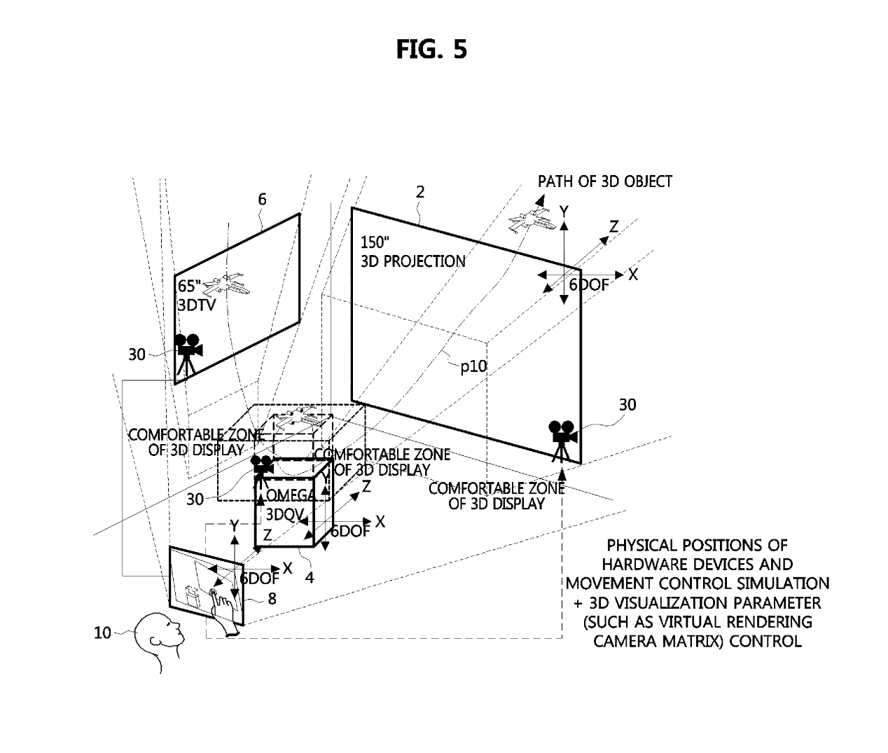

FIG. 5 is a view to explain a procedure that a producer configures an optimal demonstration environment, in a space shown in FIG. 4A, according to a scenario while the producer is moving.

Referring to FIG. 5, a producer 10 may observe the space in see-through manner by using a portable authoring device, adjust shape of each three dimensional space (for example, comfortable zone of 3D display, space having shape similar to view frustum), and set related parameters (matrix and clipping information of each virtual camera) to each virtual camera corresponding to each three dimensional space. Values of 6 degrees of freedom for each of display devices 2, 4, and 6 may be tracked by a system, and values of 6 degrees of freedom of an authoring device 8 handled by a user 10 may be tracked by a system. Thus, information on directing content may be synthesized on real object by using mixed reality technique in an image represented to the producer 10.

The producer 10 may freely move around the space in which real object and virtual content are mixed, and set optimal software control parameters (such as a shape of optimal comfort zone) for each device according to a scenario. Also, as shown in FIG. 5, movements of objects may be configured by using a touch panel 8 on which movement path of a space ship is directly drawn and an authoring interface device, or by using on-site motion capture technique based on an auxiliary device (such as a mockup) 6 DOF of which can be tracked.

For example, in the case that a 150″ three dimensional projection screen 2, a 65″ three dimensional TV 6, and a levitation type display device 4 which can visualize three dimensional image may constitute a three dimensional visualization space, and a space ship freely flies in the space, each of display devices 2, 4, and 6 may be installed in appropriate position. Also, information on identifiers and 6 DOF of display devices 2, 4, and 6 and information may be provided to the authoring device 8 in real time.

The producer may define a comfortable zone in which an experiencing person can observe three dimensional image for display devices 2, 4, and 6 naturally as a shape of view frustum, a basic concept of 3D computer graphics. Since view points can be tracked in the above situation, the zone may be configured as asymmetrical zone.

Considering a scenario and positional relations of real objects, the producer 10 may determine spaces for which each of devices 2, 4, and 6 is responsible, change positions of the devices 2, 4, and 6 so as to form a single natural space.

The determined information can be used (transferred) as configuration parameters of the virtual camera 30 controlling visualization of each of display devices 2, 4, and 7 through commands of the user interface 8. Then, the producer 10 may author movement path p10 of a space ship starting from a left-sided wall of room to a right-sided wall of room, and record it. Therefore, an experiencing person may experience a space ship (virtual object) moving through three dimensional space in a demonstration room in which a plurality of heterogeneous display device is installed.

A simulation system for mixed reality content according to the present invention may provide a convenient user interface which makes on-site real objects directly linked to simulation procedure and enables producers to perform optimization task difficult to be resolved by using only a computer system. Also, the system according to the present invention may have an effect of allowing a user to input a feedback by changing simulation condition directly on the ground, and to identify a result of inputted feedback in addition to applying mixed reality technology which combines on-site information and augmented reality and visualizing simulation result on the spot.

Also, if a content scenario is completed, an optimal simulation scenario and control parameters for content demonstration (for example, 6 DOF control values of virtual camera for three dimensional rendering, and projection matrixes) are recorded. The recorded result can be used to provide optimized mixed reality content to final experiencing users.

While the example embodiments of the present invention and their advantages have been described in detail, it should be understood that various changes, substitutions and alterations may be made herein without departing from the scope of the invention.

What is claimed is:

1. A simulation system for mixed reality contents, comprising:
at least one real object for demonstrating contents configured with a tracking sensor;
a multi-modal input-output apparatus tracking the at least one real object and collecting information on the at least one real object; and
a content authoring apparatus configured to edit virtual contents according to a predefined scenario, receive the information on the at least one real object collected by the multi-modal input-output apparatus, and edit the virtual contents based on the information on the at least one real object and a user feedback.

2. The system of claim 1, wherein the content authoring apparatus comprises:
an information collecting part receiving the information on the at least one real object collected by the multi-modal input-output apparatus;
a simulation processing part editing the virtual contents according to the predefined scenario or editing the virtual contents based on the information on the at least one real object received from the information collecting part;
a user interface part receiving the user feedback on the virtual contents edited in the simulation processing part; and
an information output part outputting the virtual contents edited in the simulation processing part,
wherein the simulation processing part is configured to edit the virtual contents additionally based on the user feedback inputted through the user interface part.

3. The system of claim 1, wherein the user interface part is configured to author positions and operation states of the virtual contents represented by the real object for demonstrating contents according to various positions and angles.

4. The system of claim 1, wherein when the at least one real object is a display device, the user interface part is configured to set regions in charge of the virtual contents for each display device.

5. The system of claim 4, wherein information on the regions in charge of the virtual contents for each display device is transferred as configuration parameters of a virtual camera controlling visualization of each display device through the information output part.

6. The system of claim 1, wherein the multi-model input-output apparatus manages the information on the at least one real object by using radio frequency identification (RFID).

7. The system of claim 1, wherein the tracking sensor has six degrees of freedom (DOF).

8. The system of claim 1, wherein the information on the at least one real object includes at least one of an identification information of the at least one real object, information of six degrees of freedom (DOF), a visual information, a hearing information, a tactile information, and an olfactory information.

9. A content authoring apparatus, comprising:
an information collecting part receiving information on at least one real object for demonstrating contents from a multi-modal input-output apparatus collecting information on the at least one real object for demonstrating contents
a simulation processing part editing the virtual contents according to a predefined scenario or editing the virtual contents based on the information on the at least one real object received from the information collecting part;
a user interface part receiving a user feedback on the virtual contents edited in the simulation processing part; and
an information output part outputting the virtual contents edited in the simulation processing part,
wherein the simulation processing part is configured to edit the virtual contents additionally based on the user feedback inputted through the user interface part.

10. The system of claim 9, wherein the user interface part is configured to author positions and operation states of the virtual contents represented by the real object for demonstrating contents according to various positions and angles.

11. The system of claim 9, wherein when the at least one real object is a display device, the user interface part is configured to set regions in charge of the virtual contents for each display device.

12. The system of claim 11, wherein information on the regions in charge of the virtual contents for each display device is transferred as configuration parameters of a virtual camera controlling visualization of each display device through the information output part.

13. The system of claim 9, wherein the information on the at least one real object includes at least one of an identification information of the at least one real object, information of six degrees of freedom, a visual information, a hearing information, a tactile information, and an olfactory information.
